(19) United States
(12) Patent Application Publication
(10) Pub. No.: US 2007/0170831 A1
(43) Pub. Date: Jul. 26, 2007

(54) Ptc element and fluorescent lamp starter circuit

(75) Inventors: Takashi Sato, Chiba (JP); Hiroyuki Koyama, Chiba (JP); Arata Tanaka, Ibaraki (JP)

Correspondence Address: TYCO ELECTRONICS CORPORATION, MAIL STOP R20/2B, 307 CONSTITUTION DRIVE, MENLO PARK, CA, 94025, US

(73) Assignee: Tyco Electronics Raychem KK, Kawasaki (JP)

(21) Appl. No.: 10/576,629

(22) PCT Filed: Oct. 20, 2004
(86) PCT No.: PCT/JP04/15469

§ 371 Date: Jan. 29, 2007

(30) Foreign Application Priority Data
Oct. 21, 2003 (JP) 2003-361011

(51) Int. Cl. H01J 61/52

(52) U.S. Cl. 313/11

(57) ABSTRACT

The present invention provides a PTC element having a novel structure and suitable for use in a starter circuit for a fluorescent lamp. The polymer PTC element (10) comprises a sheet-like body (1) made of a polymer PTC material, and the first and the second electrodes which are, for example, formed distant from each other on the same sheet surface of the sheet-like body (1) (the first electrodes 3a, 3b and the second electrodes 4a, 4b), wherein a clearance is formed between an inner wall of a through hole (7a, 7b) and a terminal (5a, 5b) as a space which at least partially traverses the sheet-like body (1) in its thickness direction.

### TECHNICAL FIELD

The present invention relates to a PTC element (or device) and a starter circuit for a fluorescent lamp which circuit incorporate a PTC element.

The term “PTC element” herein referred to means a thermistor having a Positive Temperature Coefficient, as is known in the field of the electric/electronic circuit technology. PTC elements show a low electric resistance (or impedance) under a condition of a relatively low temperature (e.g., room temperature), but steeply increases its electric resistance when the temperature exceeds a certain temperature (hereinafter referred to as a trip temperature). Throughout this description, the former state of the PTC element is called “low state,” and the latter state thereof, “high state.”

### BACKGROUND OF THE INVENTION

In the existing starter circuit for a inverter type fluorescent lamp, a ceramic PTC element and a capacitor are respectively connected to the fluorescent lamp in parallel thereto (see, for example, Patent Literature 1).

A typical electric circuit (including the existing starter circuit) for an apparatus of an inverter type fluorescent lamp is shown in FIG. 5. As in the drawings, a conventional starter circuit 60 (which means a part surrounded by the dotted lines on FIG. 5) is constructed by respectively connecting a PTC element 61 and a start capacitor 63 to a fluorescent lamp 65 in parallel thereto. The fluorescent lamp 65 is connected to an inverter circuit 70 (details thereof are omitted) via a coil 67 and a capacitor 69.

Such apparatus of the inverter type fluorescent lamp lights up as follows. First, an alternating-current power supply (not shown) is turned on to allow a high frequency current to flow in the electric circuit shown in FIG. 5. In the beginning, the PTC element 61 is in a low state and has a low impedance, so that most of the current flowing through the filaments of the fluorescent lamp 65 flows in the PTC element 61, and the filaments of the fluorescent lamp 65 and the PTC element 61 are heated due to their Joule heat. When the PTC element 61 has tripped into a high state due to its own Joule heat, the impedance of the PTC element 61 markedly increases. As a result, a high voltage is applied across the opposed ends of the fluorescent lamp, so that thermions are discharged from the heated filaments to allow the fluorescent lamp to light up. While the fluorescent lamp is lighting up, the PTC element 61 is continuously maintained in the high state even after once functioned as the starter circuit as above.

Patent Literature 1: JP-A-7-161483

### DISCLOSURE OF THE INVENTION

Problems to be Solved by the Invention

In the conventional starter circuit 60 for the fluorescent lamp as described above, the ceramic PTC element 61 has been used. Generally, such a ceramic PTC element (CPTC element) is composed of a body of a ceramic material such as an oxide semiconductor comprising, for example, barium titanate as a main component, and electrodes holding the body therebetween. It has been known that since the ceramic PTC element itself has a capacitive component due to its structure, its electric characteristics for flowing an alternating current therethrough would be changed. For this reason, intended electric characteristics can not be obtained for the PTC element in the apparatus using an alternating-current power supply.

To prevent the change in the electric characteristics of the ceramic PTC element, it is proposed to flow a direct current in the ceramic PTC element by using a rectification circuit in the starter circuit of the apparatus of the inverter type fluorescent lamp (see, for example, Patent Literature 1). However, such construction requires additional components or parts such as the rectification circuit, thus has disadvantages of a higher manufacturing cost and a larger space to be occupied.

One of the objects of the present invention is to provide a novel starter circuit for a fluorescent lamp, being capable of solving the above problems. Another object thereof is to provide a PTC element having a novel structure and suitable for use in such starter circuit for a fluorescent lamp.

Means for Solving the Problems

It has not been known concretely how much the electric characteristics of the ceramic PTC element is changed when an alternating current flows through the ceramic PTC element, particularly when an alternating current with a considerably higher frequency (e.g., 60 kHz) than the commercial frequency (50 Hz/60 Hz) flows through the apparatus of the inverter type fluorescent lamp. Thus, we have studied as the electric characteristics of a ceramic PTC element, impedance-temperature characteristics thereof particularly in a case of using an alternating current with a high frequency.

In addition to the ceramic PTC element (CPTC element), a polymer PTC element (or PPTC element) is also known as one of PTC elements in. the filed of the electric/electronic circuit technology. We have focused on the polymer PTC element and studied its electric characteristics as well.

As a result of our studies, it is observed for the ceramic PTC element that its electric characteristics in a case of using an alternating current are significantly different from those in a case of a direct current, and are changed depending on the frequency of the alternating current. For the polymer PTC element, in contrast, it does not show so large changes in the electric characteristics, as those of the ceramic PTC element. For example, it is observed that the ceramic PTC element shows a significantly decreased impedance of 1×10⁴ Ω or less, while the polymer PTC element shows a higher impedance of 1×10⁵ Ω or more both in the high state (at a frequency of about 70 kHz). It is considered that this is because the ceramic PTC element has a capacitive component, while the polymer PTC element has little capacitive component.

A starter circuit for a fluorescent lamp of the present invention is accomplished based on the foregoing studies and knowledge. According to one aspect of the present invention, there is provided a starter circuit for a fluorescent lamp (specifically, a starter circuit for an inverter type fluorescent lamp) which circuit includes a polymer PTC element. This starter circuit is assembled so that, for example, a polymer PTC element and a capacitor are respectively connected to a fluorescent lamp in parallel thereto.

The starter circuit for a fluorescent lamp of the present invention shows a lesser frequency dependency in the electric characteristics (specifically the impedance-temperature characteristics) since a polymer PTC element is used therefore, and thus can obtain a higher impedance in a high state, as compared with the conventional starter circuits using a ceramic PTC element. Consequently, power consumption of the starter circuit under a light-on condition (which means a period of time during which the fluorescent lamp actually lights up, and excludes an initial state from which the power supply is turned on and to which the fluorescent lamp lights up) can be reduced. This starter circuit for a fluorescent lamp of the present invention needs no additional component such as a rectification circuit, and thus does not cause a substantial enlargement of a space to be occupied, and applicable to the existing equipment and process for manufacturing a fluorescent lamp.

We have further studied a structure of a polymer PTC element suitable for use in such starter circuit for a fluorescent lamp, and finally accomplished a PTC element of the present invention. According to another aspect of the present invention, there is provided a PTC element (specifically, a polymer PTC element) comprising a sheet-like body made of a polymer PTC material, and a fist electrode and a second electrode formed on a surface or surfaces of the sheet-like body, characterized in that the PTC element is provided with a space which at least partially traverses the sheet-like body in its thickness direction.

According to the polymer PTC element of the present invention, since it is provided with the space (or cavity) which traverses the sheet-like body in the vertical direction (or the thickness direction), this space can absorb a thermal expansion of the sheet-like body, and thus relax heat stress. As a result, withstand voltage characteristics of the polymer PTC element of the present invention can be improved, as compared with the conventional polymer PTC element. Alternatively, it can be possible with a smaller size element to achieve the withstand voltage characteristics comparable to that of the conventional polymer PTC element. In general, the term “withstand voltage characteristics” means a period of time until the PTC element fails when a power supply is turned on and maintained as it is, or means a repeat count until the PTC element fails when the power supply is switched on and off repeatedly. For an application in a fluorescent lamp, the withstand voltage characteristics in the former case means a period of time from when a power supply is turned on till when the PTC element fails, when the PTC element is incorporated in an apparatus of the fluorescent lamp, the power supply is turned on to make the fluorescent lamp light-on and then the PTC element is maintained under a voltage condition applying, for example, a peak voltage of 1 kV is applied, followed by about 50 to 150 V to the PTC element. On the other hand, the withstand voltage characteristics in the latter case means a number of repeating cycle until the PTC element fails, when the PTC element is incorporated in an apparatus of the fluorescent lamp, the power supply is switched on and off repeatedly with a certain period to make the fluorescent lamp light-on and light-off under the voltage condition as described above.

The space mentioned above can be at least partially defined by an inner wall of a through hole which extends through the sheet-like body. For example, the above space may be a whole of the through hole when there is nothing in the through hole, or the space may be a clearance defined between the inner wall of the through hole and an insert when there is the insert such as a terminal in the through hole. In another case, the above space may be a cavity or recess which extends to the middle of the sheet-like body. The position, shape and size of the space may be appropriately selected in consideration of a relationship between an electrode and a terminal as hereinafter described, preferably so as not to give any substantial influence on the electric characteristics of the PTC element. The number of such spaces is not limited, as long as at least one such space is formed, but two or more of such spaces are preferably formed so as to efficiently absorb the thermal expansion and the heat stress.

In one mode of the present invention, the first electrode and the second electrode of the PTC element are formed distant from each other on the same sheet surface of the sheet-like body. According to this arrangement, in the event that a failure arises in the PTC element, the PTC element fails in an open mode without short circuit to realize a fail safe, so that the safety of the PTC element is improved. This is considered that fatigue due to the repeated heat stress concentrates on a part of the sheet-like body in proximity of an outer periphery of the electrode, and therefore that the PTC element tends to be broken at such part thereof in the event of the failure. The distance between the first electrode and the second electrode is preferably not smaller than the thickness of the sheet-like body. Such distance can more likely to cause the open mode failure in the event of the PTC element failure.

In another mode of the present invention, the first electrode and the second electrode of the PTC element are respectively formed on a pair of opposed sheet surfaces of the sheet-like body, so as not to overlap each other as they are seen by being projected in the vertical direction (or the thickness direction of the sheet-like body). Also in this mode, similar effects to that of the former mode can be obtained, and the distance between the first electrode and the second electrode when they are seen by being projected, is preferably not smaller than the thickness of the sheet-like body for the similar reason.

However, the present invention is not limited to these modes, and the first electrode and the second electrode of the PTC element may be situated with any suitable relationship between them. As the first electrode and the second electrode, it is only necessary to have two kinds of electrodes. having different electric potentials from each other. The first electrode can be in the form of plural electrodes, and the same applies to the second electrode. Further, at least two kinds of electrodes having different electric potentials should be present, and three or more kinds of electrodes may be present. For example, the first to the third or more electrodes can be located distant from and in parallel to one another on the same sheet surface of the sheet-like body, or these electrodes can be located alternately and in parallel to one another on the opposed sheet surfaces of the PTC element. Terminals are fixed to the electrodes respectively, for example, by soldering.

As to the relationship between the above space and the electrode, the space is located within a region surrounded by an outer periphery of the electrode as the space and the electrode are seen by being projected in the vertical direction (the thickness direction of the sheet-like body), and preferably at a position near an operation part. In this case, the section of the space in the horizontal direction is smaller than the region surrounded by the outer periphery of the electrode. When plural spaces are formed in the PTC element, one or more spaces can be formed per one electrode of the PTC element. This space can be formed so as to penetrate the electrode.

The relationship between the above space and the terminal is not limited to, but can be as follows. In an example, when a profile of a wall defining the space is larger than the section of the terminal as seen from the vertical direction, the terminal may be inserted through or in the middle of this space so as to leave a clearance between the profile and the terminal. In other example, when the profile of the wall defining the space is smaller than the section of the terminal, the space and the terminal may be located adjacent to each other so that an opening of the space is closed with an end portion of the terminal. In further example, when the section of the terminal in the horizontal direction gradually changes, the terminal may be fitted in the wall defining the space up to a position at which the profile of the wall defining the space is equal to the section of the terminal in the horizontal direction.

As to the present invention, the term “sheet-like” means a form of a sheet and/or a layer or others having a substantially rectangular section. The “sheet-like body” may be an article of which a pair of opposed sides is considerably longer than another pair of opposed sides in the substantially rectangular section, or may be a slice cut out of such article. In the latter case, the pair of opposed sides in the substantially rectangular section of the “sheet-like body” are not necessarily considerably longer than another pair of opposed sides. The term “sheet surface” means a surface of the sheet-like body which surface include a longer side of the substantially rectangular section of the sheet-like body. Throughout the description, the term “vertical direction” means the thickness direction of the sheet-like body, and the term “horizontal direction” means a direction along the sheet surface.

The PTC element of the present invention as described above are suitably used in an application where the PTC element frequently trips between the low state and the high state to undergo expansion and contraction by heat, repeatedly. Therefore, the PTC element of the present invention is preferably incorporated into a starter circuit for a fluorescent lamp of the present invention, particularly a starter circuit for an inverter type fluorescent lamp. In addition to the starter circuit for a fluorescent lamp, the PTC element of the present invention can be preferably used in a startup circuit which is connected to an alternating-current power supply and requires a large current only at startup. However, it should be noted that the PTC element of the present invention is not limited to these applications, but can be used in other applications having the problems of expansion/contraction by heat.

### EFFECT OF THE INVENTION

According to the present invention, there is provided a more efficient and novel starter circuit for a fluorescent lamp. Since the starter circuit for a fluorescent lamp of the present invention uses a polymer PTC element, it shows a lesser frequency dependency in their electric characteristics, and results in a lower power consumption by the PTC element under the light-on condition, as compared with the conventional starter circuit using a ceramic PTC element.

Further, according to the present invention, there is also provided a PTC element suitable for use in a starter circuit for a fluorescent lamp. According to the PTC element of the present invention, since it is provided with a space which at least partially traverses the sheet-like body in the thickness direction, this space can absorb thermal expansion and/or heat stress caused in the sheet-like body, and thus the withstand voltage characteristics of the PTC element are improved, as compared with the polymer PTC element having a conventional structures.

### BRIEF DESCRIPTION OF DRAWINGS

FIG. 1 schematically shows a polymer PTC element in one embodiment of the present invention, wherein FIG. 1(a) is a sectional view, FIG. 1(b) is a sectional view taken along line A-A′ in FIG. 1(a), and FIG. 1(c) is a sectional view corresponding to FIG. 1(a) but in failure.

FIGS. 2(a) and 2(b) schematically show sectional views of polymer PTC elements in varieties of embodiments of the present invention.

FIG. 3 shows graphs of resistance-temperature characteristics of PTC elements (direct current), wherein FIG. 3(a) is the graph for a polymer PTC element, and FIG. 3(b) is the graph for a ceramic PTC element.

FIG. 4 shows graphs of impedance-temperature characteristics (alternating current) of PTC elements, wherein FIG. 4(a) is the graph for a polymer PTC element, and FIG. 4(b) is the graph for a ceramic PTC element.

FIG. 5 shows an electric circuit diagram of an inverter type fluorescent lamp including a conventional starter circuit.

FIG. 6 schematically shows one type of the conventional polymer PTC elements, wherein FIG. 6(a) is a sectional view and FIG. 6(b) is a top plan view.

FIG. 7 schematically shows other type of the conventional polymer PTC elements, wherein FIG. 7(a) is a sectional view, and FIG. 7(b) is a sectional view corresponding to FIG. 7(a) but in failure.

### DESCRIPTION OF NUMERALS

1, 81, 91: sheet-like body

3a, 3b, 4a, 4b, 83a, 83b, 93a, 93b: electrode (metal part)

5a, 5b, 85a, 85b, 95a, 95b: terminal

7a, 7b: through hole

9a, 9b, 89a, 89b: solder connecting part

10, 80, 90: polymer PTC element

60: starter circuit

61: PTC element

63: start capacitor

65: fluorescent lamp

67: coil

69: capacitor

70: inverter circuit

### BEST MODES FOR CARRYING OUT THE INVENTION

### Embodiment 1

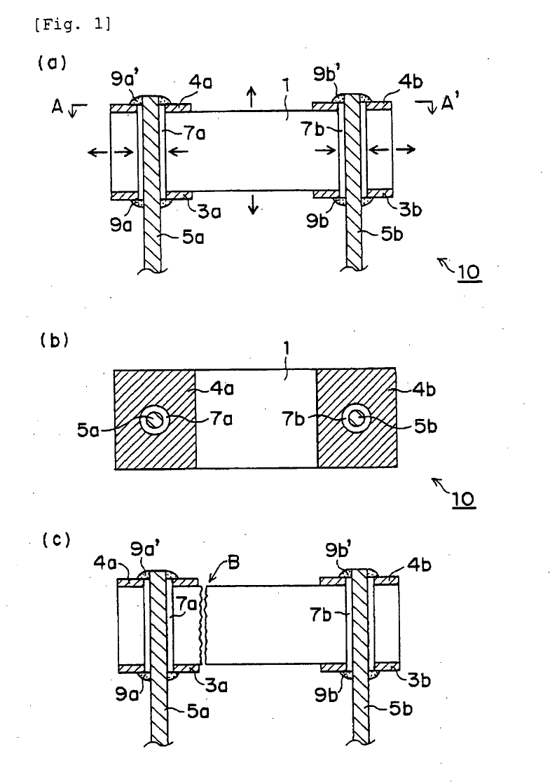

This embodiment relates to a polymer PTC element. As shown in FIGS. 1(a) and 1(b), in a polymer PTC element 10 of this embodiment, a sheet-like body 1 made of a polymer PTC material has a pair of opposed sheet surfaces, on one of which metal parts 3a and 3b are formed, and the other of which metal parts 4a and 4b are formed. These metal parts 3a and 3b are located on the same sheet surface distant from each other preferably with a distance not smaller than the thickness of the sheet-like body 1. The lmetal parts 4a and 4b are also located in the same manner. A through hole 7a is formed to penetrate the sheet-like body 1 and the metal parts 3a and 4a , and a through hole 7b is also formed to penetrate the sheet-like body 1 and the metal parts 3b and 4b . Spaces (or clearances) are left between terminals 5a and 5b and inner walls of the through holes 7a and 7b , respectively.

In this embodiment, the terminals 5a and 5b extend from one sheet surface of the sheet-like body 1 in the vertical direction, pass through the insides of the through holes 7a and 7b , and project from the opposing sheet surface. The terminal 5a is fixed to the metal parts 3a and 4a with solder connecting parts 9a and 9a′, respectively. The terminal 5b is fixed to the metal parts 3b and 4b with solder connecting parts 9b and 9b′, respectively. The metal parts 3a and 4a function as the first electrode in the same electric potential, and the metal parts 3b and 4b function as the second electrode in the same electric potential.

For example, the sheet-like body 1 may have a shape of a rectangular parallelepiped of about 3 mm in width×about 11 mm in length×about 1 mm in thickness, and the metal parts 3a, 3b, 4a and 4b may have a shape of a rectangular parallelepiped of about 3 mm in width×about 3 mm in length×about 0.03 mm in thickness. The through holes 7a and 7b may have a cylindrical shape with a diameter of about 0.8 mm, and the terminals 5a and 5b may have a cylindrical shape with a diameter of about 0.7 mm. In the embodiment shown in the drawings, the through holes 7a and 7b are located at the center portions of the regions surrounded by the outer peripheries of the metal parts 3a and 4a, and 3b and 3b, as seen by being projected in the vertical direction. It is considered, however, that the through holes 7a and 7b are preferably located near an operating portion (in the proximity of the center portion of the sheet-like body 1 in this embodiment). These details are described for the purpose of illustrative examples only, and those skilled in the art may appropriately select the dimensions, shapes and so on for each of the components.

This polymer PTC element 10 is can be produced as follows. First, a sheet-like polymer PTC material is prepared. The polymer PTC material can be a material, for example, where conductive particles such as carbon black are dispersed in a polymer material such as polyethylene. Metal foils such as Cu foils are applied to each of the sheet surfaces in pairs of the sheet-like polymer PTC material, and if needed, the metal foils may be plated with Ni or the like. The resultant sheet is bored with a drill to form the through holes 7a and 7b. Preferably, this drilling is carried out before etching to improve the mechanical strength of the element. After that, the metal foils (which may be plated in some cases) are etched in a certain pattern to form the metal parts 3a, 3b, 4a and 4b, and then the sheet is cut into chips with the predetermined size. Then, commonly used terminals 5a and 5b made of a metal such as Cu (which may be plated) are fixed and connected to the metal parts 3a and 3b by soldering, respectively. Thus, the polymer PTC element 10 is produced. This polymer PTC element 10 is generally coated with, for example, a silicone resin or the like.

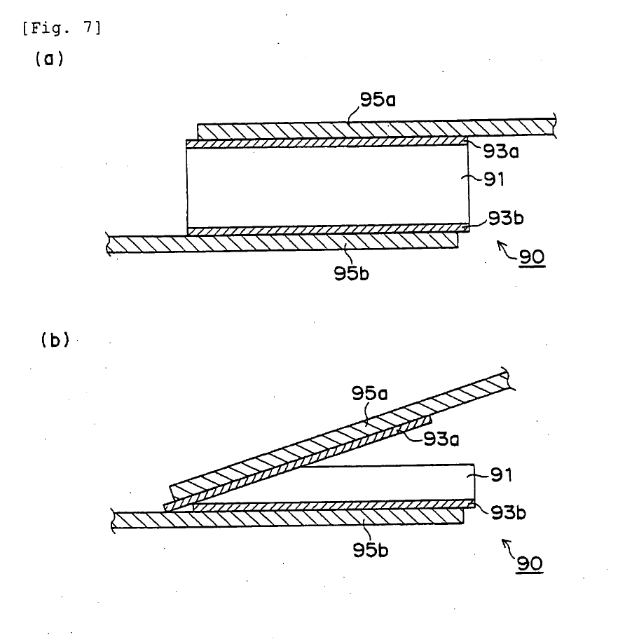

A polymer PCT element 80 shown in FIGS. 6(a) and 6(b) is known as one type of the conventional polymer PTC elements, wherein electrodes 83a and 83b are located away from each other on one sheet surface of a sheet-like body 81 made of a polymer PTC material, and terminals 85a and 85b are fixed with solder connecting parts 89a and 89b on the electrodes 83a and 83b and respectively extend therefrom in the horizontal direction in parallel each other. When such conventional polymer PTC element 80 is subjected to a withstand voltage test, the polymer PTC element is repeatedly expanded and contracted due to heat cycles (arrows shown in FIG. 6(a) schematically indicate examples of the expanding directions) and is fatigued due to heat stress and finally fails.

In contrast, according to the polymer PTC element 10 of this embodiment, the spaces between the terminals 5a and 5b and the inner walls of the through holes 7a and 7b formed in the sheet-like body 1 absorb the thermal expansion (arrows shown in FIG. 1(a) schematically indicate examples of the expanding directions for the better understanding), and thus relax the heat stress. Consequently, the lifetime of this polymer PTC element 10 up to a failure thereof can last longer, and the withstand voltage characteristics thereof is improved, as compared with the conventional polymer PTC element 80.

A polymer PCT element 90 shown in FIG. 7(a) is also known as other type of the conventional polymer PTC elements, wherein a sheet-like body 91 made of a polymer PTC material is held between electrodes 93a and 93b from which terminals 95a and 95b respectively extend in the horizontal and opposed directions. As to such conventional polymer PTC element 90, a failure mode as shown in FIG. 7(b) is possibly caused in the event of failure by an accidental and external factor (e.g., a mechanical contact).

In contrast, in the event of failure the polymer PTC element 10 of this embodiment fails in an open mode by causing a crack in the proximity of the electrode as shown in FIG. 1(c), and thus avoid a short circuit. Consequently, the polymer PTC element 10 is improved in safety, as compared with the conventional polymer PTC element 90. This is considered, while not restricted by any of theories, as follows. As a result of complex influence of various factors such as differences over the internal heat distribution and heat discharge of the sheet-like body 1, and difference in the coefficient of thermal expansion between the sheet-like body 1 and the metal parts 3a, 4a, 3b and 4b made of the metal material, the fatigue by heat stress is concentrated on a part of the sheet-like body 1 particularly in the proximity of the outer periphery B of the metal part 3a, 4a, 3b or 4b locating at a near side to the center portion of the PTC element, so that in the event of failure the element preferentially fails by causing a crack from this part.

In order to bring about the open mode failure more preferentially, a notch may be formed at the part of the sheet-like body in the proximity of the outer periphery of at least one of the metal parts 3a, 3b, 4a and 4b locating at the near side to the center of the PTC element.

While the PTC element in the one embodiment of the present invention has been described as above, the present invention is not limited to this, and those skilled in the art could readily understand that this embodiment may be modified in various ways without departing the spirit of the present invention. For example, the metal parts 4a and 4b are present and connected to the terminals 5a and 5b with the solder connecting parts 9a′ and 9b′ in this embodiment, but the metal parts 4a and 4b and the solder connecting parts 9a′ and 9b′ may be omitted.

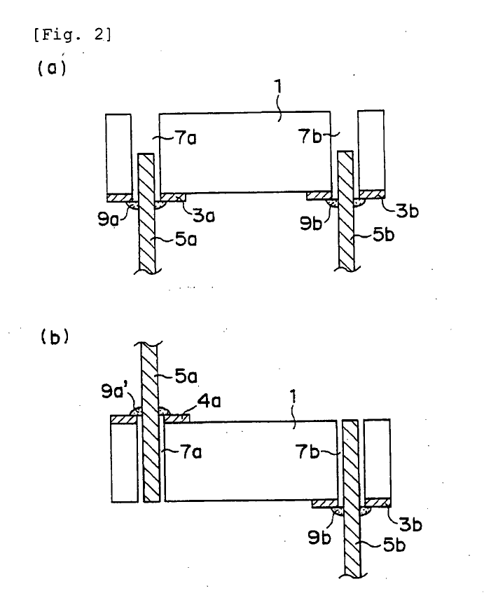

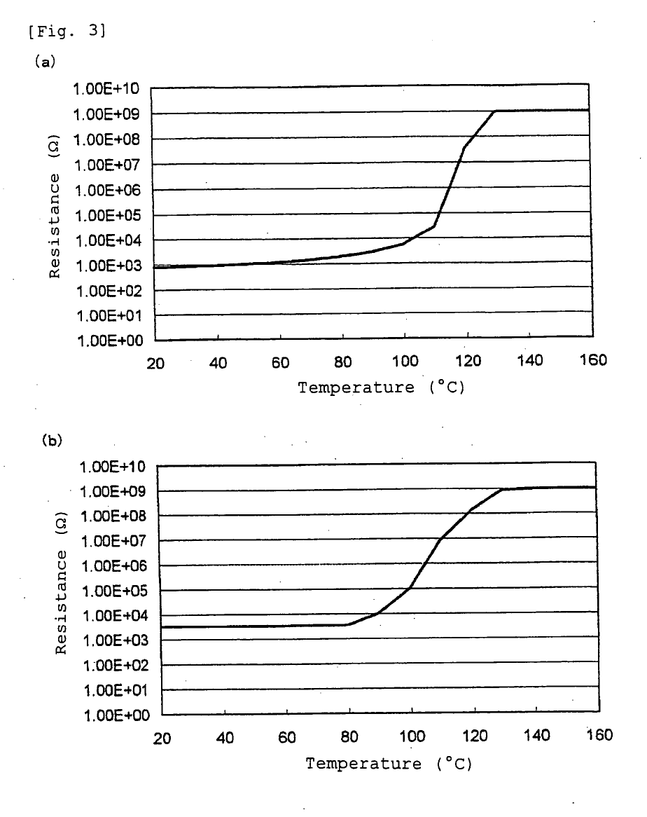

Further, the terminals 5a and 5b are passed through the sheet-like body 1 in the through holes 7a and 7b in this embodiment, but the terminals 5a and 5b may be inserted halfway into the through holes 7a and 7b as shown in FIG. 2(a).

Furthermore, as shown-in FIG. 2(b) the terminals 5a and 5b may be connected to the metal parts 4a and 3b, respectively. In this case, the metal parts 4a and 3b function as electrodes. These metal parts 4a and 3b are formed on the opposed sheet surfaces of the sheet-like body 1, respectively, so as not to overlap each other as they are seen by being projected in the vertical direction.

Although the space(s) is in the form of the clearance between the through hole and the terminal in this embodiment, no terminal may be inserted into the through hole to utilize the whole of the through hole as a space. Otherwise, the space may be in the form of a recess which extends halfway into the sheet-like body, and such space can also absorb the thermal expansion.

### Embodiment 2

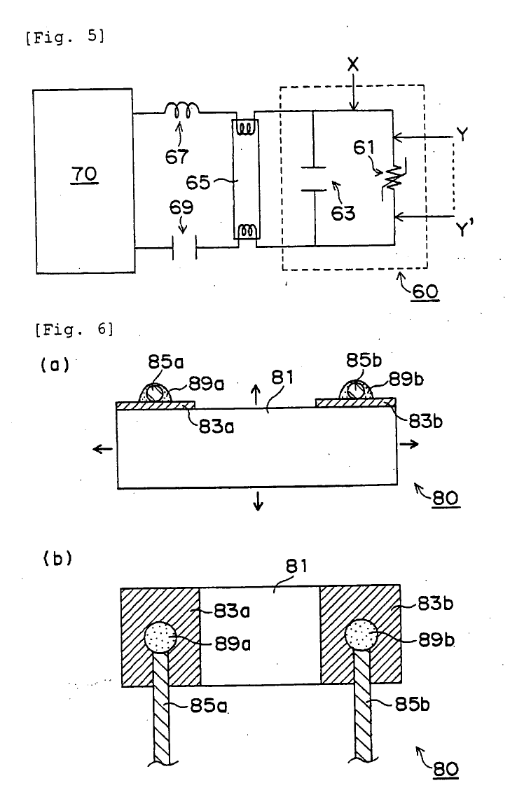

This embodiment relates to a starter circuit for a fluorescent lamp, which circuit applies a polymer PTC element. A starter. circuit (not shown) for a fluorescent lamp of this embodiment is assembled by using the polymer PTC element 10 of Embodiment 1 in the conventional starter circuit of the apparatus of the inverter type fluorescent lamp shown in FIG. 5 in place of the ceramic PTC element 61.

Thus resultant starter circuit for a fluorescent lamp of this embodiment shows a lesser frequency dependency in its electric characteristics, and thus can achieve a reduced power consumption of the starter circuit under the light-on condition, as compared with the conventional starter circuits using the ceramic PTC element 61.

In particular, since this embodiment uses the polymer PTC element of Embodiment 1, it has advantages of the improved withstand voltage characteristics and the higher safety as described in Example 1, as compared with a case in which any other known polymer PCT element is applied in the conventional starter circuit for a fluorescent lamp in place of the ceramic PTC element.

While the starter circuit in the one embodiment of the present invention has been described as above, this embodiment may also be modified in various ways without departing the spirit of the present invention. For example, the circuit arrangement shown in FIG. 5 is employed in this embodiment, but the present invention is not limited to this, and any other suitable arrangement of the starter circuit for a fluorescent lamp may be employed.

Further, the polymer PTC element of Embodiment 1 is used in this embodiment, but a polymer PTC element of any other embodiment of the present invention may be used. Any polymer PTC element known in this technical field may also be used, and this case also can have the advantages of the lesser frequency dependency in its electric characteristics and the reduced power consumption of the starter circuit under the light-on condition, as compared with the conventional starter circuits using a ceramic PTC element.

### EXAMPLES

1. Characteristics of Element

Electric characteristics of a polymer PTC element of the present invention were examined. In this regard, either a resistance or an impedance of the polymer PTC element was measured after the polymer PTC element had been maintained under a predetermined temperature condition in the range of 20 to 160° C. for 15 minutes. While a value of the temperature condition was an ambient temperature surrounding the PTC element, it can be regarded as the temperature of the PTC element itself.

First, the polymer PTC element of Embodiment 1 was produced, and a ceramic PTC element for comparison was commercially obtained. With respect to the polymer PTC element and the ceramic PTC element, resistance-temperature characteristics of the element were examined by measuring a resistance value of the element alone in a case of a direct current with an ordinary direct-current ohm meter, under various temperature conditions. The results are shown in FIGS. 3(a) and 3 (b).

As is understood from the graphs of FIGS. 3(a) and 3(b), the resistance in the low state of the polymer PTC element is lower than that of the ceramic PTC element, however, the resistance in the high state of the polymer PTC element was little different from that of the ceramic PTC element.

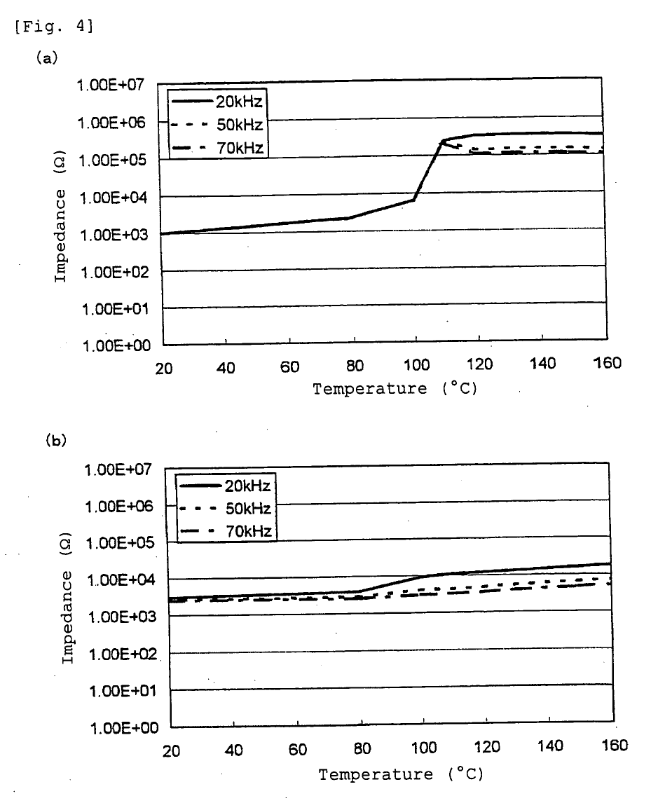

With respect to the polymer PTC element and the ceramic PTC element which were the same as the above, impedance-temperature characteristics of the element were then examined by measuring an impedance value of the element alone in a case of an alternating current with an ordinary LCR meter, under various temperature conditions. For the measurements, the alternating-current frequency was changed to 20 kHz, 50 kHz and 70 kHz, and the resistance value was measured for each of the frequencies. The results are shown in FIGS. 4(a) and 4 (b).

As to the ceramic PTC element, it was found by comparing the resistance value in the case of the direct current (FIG. 3(b)) with the impedance value in the case of the alternating current (FIG. 4 (b)), that the case of the alternating current showed a lower value in the high state and tendency of smaller difference between the values in the high state and in the low state, as compared with the case of the direct current. As to the polymer PTC element, on the other hand, the similar tendency was observed by comparing the resistance value in the case of the direct current (FIG. 3(a)) with the impedance value in the case of the alternating current (FIG. 4(a)), but its tendency was not so significant as that of the ceramic PTC element.

In the case of the alternating current, referring to FIGS. 4(a) and 4 (b), the polymer PTC element (FIG. 4(a)) as compared with the ceramic PTC element (FIG. 4(b)) showed a lower impedance in the low state and a higher impedance in the high state, thus showing a larger difference in impedance and a steeper change in impedance. Especially at 70 kHz, which is close to the frequency used for inverter type fluorescent lamps, the impedance in the high state was not lower than 1×10⁵ Ω for the polymer PTC element, while it was not higher than 1×10⁴ Ω for the ceramic PTC element.

On the basis of the above results, according to the polymer PTC element in the example of the present invention, the obtained impedance in the high state is higher than that of the ceramic PTC element in the comparative example, and therefore when it is used in a starter circuit for a fluorescent lamp, it can be expected to reduce a power consumption of the starter circuit under the light-on condition. In addition, according to the polymer PTC element in the example of the present invention, the obtained impedance in the low state is lower than that of the ceramic PTC element in the comparative example, and therefore when it is used in a starter circuit for a fluorescent lamp, heating of filaments for making the fluorescent lamp light up can be conducted more effectively, and it can be expected to shorten a time period required for making the fluorescent lamp light up after a power supply has been switched on.

As is understood from FIGS. 4(a) and 4(b), the impedance in the high state for the ceramic PTC element in the comparative example was decreased overall as the frequency was increased, on the other hand, that for the polymer PTC element in the example of the present invention was decreased overall in a temperature range higher than about 110° C. as the frequency was increased, but showed high values in a temperature range not higher than about 110° C. almost independently of the frequency.

On the basis of the above results, it has been confirmed that while the electric characteristics of the ceramic PTC element in the comparative example changes depending on the frequency, the electric characteristics of the polymer PTC element in the example of the present invention did not substantially depend on the frequency.

2. Characteristics of Starter Circuit

Also, electric characteristics of a starter circuit for a fluorescent lamp using the polymer PTC element of the present invention were examined. As a reference for characteristics of the used PTC element, a value of an initial impedance of the PTC element was measured beforehand (see Table 1). The initial impedance was measured for the element alone (at a room temperature (about 25° C.), a frequency of 1 kHz) with the same LCR meter as used for examining the characteristics of the element in the above.

Firstly, the starter circuit for a fluorescent lamp of Embodiment 2 was assembled by using the polymer PTC element in the example, of which characteristics were examined in the above, in the starter circuit shown in FIG. 5 in place of the ceramic PTC element 61. The used fluorescent lamp was a commercially available inverter type fluorescent lamp bulb. While inserting an ordinary alternating-current ammeter into the starter circuit of this example at the point X and connecting an ordinary alternating-current voltmeter to it at the points Y and Y′, an alternating current with a high frequency was allowed to flow the circuit to measure a current and a voltage of the PTC element under the light-on condition. In addition, a starter circuit for a fluorescent lamp was likewise assembled by using the ceramic PTC element of the above comparative example, and this starter circuit in the comparative example was subjected to the same tests. The results are shown in Table 1. The measured values of currents and voltages in Table 1 were effective values.

TABLE 1

| | Element | | | |
|---|---|---|---|---|
| | alone | Starter Circuit | | |
| | Initial | Current | Voltage | Frequency |
| | Impedance (Ω) | (mA) | (V) | (kHz) |
| Example | 796.8 | 8.8 | 57.1 | 62.2 |
| Comparative | 3177 | 17.4 | 66.1 | 61.3 |
| Example | | | | |

Also from the measured values of the currents and the voltages shown in Table 1, it can be supposed to reduce the power consumption of the starter circuit under the light-on condition, since the starter circuit in the comparative example showed leakage of the current into the ceramic PTC element under the light-on condition, but the starter circuit in the example of the present invention showed a relatively less current flowing into the polymer PTC element.

Moreover, surface temperatures of the PTC elements of the starter circuits in the example and the comparative example were measured under the light-on condition (after 15 minutes had passed). The highest temperatures of the polymer PTC element and the ceramic PTC element were found to be almost the same. Thus, it has been found that the use of the starter circuit of the present invention in place of the conventional starter circuit causes no problem from the viewpoint of heat.

### INDUSTRIAL APPLICABILITY

The polymer PTC element of the present invention is applicable in switching elements in the field of the electric/electronic technology. The starter circuit for a fluorescent lamp of the present invention may be preferably used especially for inverter type florescent lamps.

1. A PTC element comprising a sheet-like body made of a polymer PTC material, and first and second electrodes formed on a surface or surfaces of the sheet-like body, characterized in that the PTC element is provided with a space which at least partially traverses the sheet-like body in its thickness direction.

2. The PTC element according to claim 1, wherein the space is at least partially defined by an inner wall of a through hole which extends through the sheet-like body.

3. The PTC element according to claim 1, wherein the first and second electrodes are formed distant from each other on the same sheet surface of the sheet-like body.

4. The PTC element according to claim 1, wherein the first and second electrodes are respectively formed on a pair of opposed sheet surfaces of the sheet-like body, so as not to overlap each other as they are seen by being projected in the thickness direction of the sheet-like body.

5. The PTC element according to claim 1, wherein the space is located within a region surrounded by an outer periphery of the electrode as it is seen by being projected in the thickness direction of the sheet-like body.

6. The PTC element according to claim 5, wherein the space penetrates at least one of the electrodes.

7. A starter circuit for a fluorescent lamp, comprising a polymer PTC element.

8. The circuit according to claim 7, wherein the PTC element comprises a sheet-like body made of a polymer PTC material, and first and second electrodes formed on a surface or surfaces of the sheet-like body, characterized in that the PTC element is provided with a space which at least partially traverses the sheet-like body in its thickness direction.
